(19) United States
(12) Patent Application Publication
(10) Pub. No.: US 2025/0223867 A1
(43) Pub. Date: Jul. 10, 2025

(54) LITE UNIT FRAME AND SYSTEMS AND METHODS FOR PROVIDING POWER UNIT INTEGRATION IN A LITE UNIT FRAME

(71) Applicant: Masonite Corporation, Tampa, FL (US)

(72) Inventors: Alex BODURKA, Portage, MI (US); Michael FUQUA, Chicago, IL (US)

(21) Appl. No.: 19/014,917

(22) Filed: Jan. 9, 2025

Related U.S. Application Data
(60) Provisional application No. 63/619,050, filed on Jan. 9, 2024.

(51) Int. Cl. E06B 9/24; E06B 3/54; H02S 20/26

(52) U.S. Cl. CPC E06B 9/24; E06B 3/549; E06B 2009/2464; E06B 2009/2476; H02S 20/26

(57) ABSTRACT

Aspects of the present disclosure describe a lite unit frame and a system and method for power unit integration into a lite unit frame.

### CROSS-REFERENCE TO RELATED APPLICATIONS

This application claims the benefit of U.S. Application No. 63/619,050, filed Jan. 9, 2024, the contents of which are incorporated by reference herein in their entirety.

### FIELD

The present technology is directed to exterior or interior doors and windows for residential or commercial buildings, such as for a home, apartment, condominium, hotel room or business, and more particularly to a lite unit frame and system and method for power unit integration into a lite unit frame.

### BACKGROUND

Typical existing exterior or interior doors for residential or commercial buildings may have a number of electric devices (or components) mounted to the doors in order to provide desired functions, including peripheral devices such as electronic locks and latches, access control systems, doorbells, cameras, intercoms, door state feedback, etc. Also, the market for exterior and interior doors has seen an increasing adoption of additional electric devices including video doorbells, smart locks, LED lighting, smart glass, electromechanical door closers, wireless connectivity electronics, etc.

Current smart glass technologies, e.g., require dedicated power to maintain lite status in at least one state. To accomplish this, the lite itself requires dedicated wiring either to a power bank located elsewhere in the slab beyond the lite kit itself, or else from a connected wire passage from the door slab out through the door system to a sourced input from the home or building in which the door system is installed.

The present disclosure advantageously recognizes a need in the art for and provides a lite kit unit frame that can be easily installed, e.g., as a standalone smart glass device, complete with an integrated power source, without requiring in-door wiring. This allows for facile installation in a new door or for a retrofit into any door slab, interior or exterior, or framed door, e.g., a patio door, where that door includes a cutout, hole or opening having a shape configured to receive the frame (or where the frame and glass lite are configured with a size and shape for the cutout, hole or opening in the door).

### SUMMARY

As is noted above, the present disclosure generally relates to exterior or interior doors and windows for residential or commercial buildings, such as for a home, apartment, condominium, hotel room or business, and more particularly to a lite kit unit, system and method for doors and windows that provide standalone powered lite unit integration.

In exemplary aspects, wiring and at least one power source is provided in the lite kit unit for a glass internal lite, at least partially within a frame, which is configured to contain wiring and the at least one power source within at least a portion of the frame.

In further exemplary aspects, an exterior portion or circumference of the frame is configured to engage the slab to hold the glass internal lite in place relative thereto.

In further exemplary aspects, the frame is configured to at least partially clamp to the door slab, e.g., partially in one or more discrete locations around the exterior circumference of the frame. In additional exemplary aspects, the frame is configured to at least partially clamp to the glass internal lite, e.g., partially in one or more discrete locations around the interior circumference of the frame.

In further exemplary aspects, the frame is provided in at least two clamping pieces, with a first side clamping to a second side across the door slab to secure the frame relative thereto. In exemplary aspects, a plurality of fasteners, such as bolts, screws, etc., are provided to secure the frame relative to the door slab and/or the glass internal lite. In exemplary aspects, the plurality of fasteners extend through a first frame piece and between the interior and exterior portions to directly engage the second frame piece on the other side, sandwiching the glass internal lite in the interior periphery of the first and second frame pieces and sandwiching the door slab in the exterior periphery of the first and second frame pieces for easy installation or removal of glass kit unit relative to the door slab.

In additional exemplary aspects, the frame includes conductive contact pads on an interior periphery portion to provide power from the power source to conductive contact points on smart glass.

In other exemplary aspects, the frame includes conductive contact pads interior periphery portion to provide data from a data connection to conductive contact points on the smart glass.

In additional exemplary aspects, the at least one power source is a battery, wireless power unit, solar power unit, or other power source contained within the frame. For wireless power and/or data units, in exemplary aspects, the frame includes a receiver or receiver and transmitter.

In further exemplary aspects, a wire connector is provided at least partially through the frame to an external portion thereof to allow for connection to one or more power or data sources, e.g., a wireless power source and/or data connection, a solar power source, etc., as a supplemental power or data source or as an alternative to one or both of power and data provided from within the frame.

In exemplary aspects, the smart glass is of the type that has memory such that it retains its current state (e.g., remaining opaque or transparent in the powered off state) for a predetermined amount of time unless a power source provides a switching signal to induce a state transfer.

In other exemplary aspects, a portion of the frame provides an accessible opening to replace or recharge a power source provided therein, e.g., as a battery compartment.

In further exemplary aspects, the frame includes a user interface, e.g., a trigger, button, contact pad, display, etc., that allows user control of the smart glass. In further exemplary aspects, the glass lite unit includes a wireless data interface within the frame communicating with a user device, such as a smart phone, wireless home control unit, etc., for control of the smart glass. In additional or alternative exemplary aspects, a sensor in the frame and/or a sensor in wireless data communication with smart glass is used to trigger a change in or otherwise control the smart glass.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 is a perspective schematic view of installation of an exemplary lite unit into a door slab using plural fasteners between opposing frame portions, according to an exemplary embodiment provided herein;

FIG. 2A is front elevation view of an insulated glass unit (IGU) with an electronic glass pane, according to an exemplary embodiment provided herein;

FIG. 2B is a side elevation view of the IGU and electronic glass pane of FIG. 2A;

FIG. 3 is a perspective view of an exemplary frame having two sandwiching parts for the smart glass and for the door slab, including conductive contact pads, according to an exemplary embodiment provided herein;

FIG. 4 is a perspective view of an exemplary frame having two sandwiching parts for the smart glass and for the door slab, including a wired connector, according to an exemplary embodiment provided herein;

FIG. 5 is a perspective view of an exemplary frame having two sandwiching parts for the smart glass and for the door slab, including both a wired connector and a conductive contact pad, according to an exemplary embodiment provided herein; and

FIG. 6 is illustration of a schematic showing the stack up of a smart glass lite kit unit that includes a transparent photovoltaic layer for solar charging of energy storage device, according to an exemplary embodiment provided herein.

### DETAILED DESCRIPTION

Reference will now be made in detail to the exemplary embodiments and exemplary methods as illustrated in the accompanying drawings, in which like reference characters designate like or corresponding parts throughout the drawings. It should be noted, however, that the invention in its broader aspects is not necessarily limited to the specific details, representative materials and methods, and illustrative examples shown and described in connection with the exemplary embodiments and exemplary methods.

This description of exemplary embodiments is intended to be read in connection with the accompanying drawings, which are to be considered part of the entire written description. In the description, relative terms such as “horizontal,” “vertical,” “front,” “rear,” “upper”, “lower”, “top” and “bottom” as well as derivatives thereof (e.g., “horizontally,” “vertically,” “downwardly,” “upwardly,” etc.) should be construed to refer to the orientation as then described or as shown in the drawing figure under discussion and to the orientation relative to door, door frame, etc., These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. The term “integral” (or “unitary”) relates to a part made as a single part, or a part made of separate components fixed (i.e., non-moveable) and connected together. Additionally, the word “a” and “an” as used in the claims means “at least one” and the word “two” as used in the claims means “at least two.”

Without limitation, the present disclosure relates to doors, door frames, door slabs (e.g., foam filled doors, solid core fiberglass doors, steel exterior doors, molded pane MDF hollow or solid core interior doors, patio doors (which may have frames holding glass or other materials therein), other frames, such as window frames, door lites, which may be in doors, e.g., as a window provided therein, or adjacent doors (e.g., providing windows left and/or right of an entry door), interior doors, hanging doors, folding doors, smart doors, etc. As is noted above, exemplary embodiments described herein relate to powered lite frames and units.

As is described in exemplary embodiments herein, the present disclosure particularly relates to a smart glass unit, as a standalone device, with a frame that includes in various embodiments, wiring, electric contacts, at least one power source, etc., and that secures the smart glass provided within that frame to another frame, opening, cutout, etc., in a door, door lite, window, or other opening, for facile installation or removal of that standalone smart glass device therein.

In exemplary aspects, the present disclosure advantageously describes a lite kit unit, system and method for doors that provide standalone electronic smart glass integration. It should be noted that the “lite kit unit”, “smart glass unit” or similar terms referenced herein encompass all of the various embodiments described herein that includes smart glass within a frame, with the various alternative or additive features also described in this specification and/or shown in the drawings. Further, exemplary embodiments may refer to the frame as a “lip lite” frame, which is configured to clamp around the exterior of a smart glass pane and around an opening in a door or door slab (the door having a passage hole cut into it or otherwise provided through a portion of it), or indeed any opening provided in a door, window, wall, etc., for facile installation therein. Such clamping may be via any desired mechanism, such as a plurality of bolts, screws, etc. provided from one side of the frame to the other, or via some other clamping mechanism between two opposing portions of the frame.

In exemplary aspects, wiring and at least one power source is provided in the lite kit unit for a glass internal lite, at least partially within a frame, which is configured to contain wiring and the at least one power source within at least a portion of the frame. Exemplary frames may be made of, e.g., thermoplastics, molded thermosets, metal, etc.

In further exemplary aspects, an exterior portion or circumference of the frame is configured to engage the slab to hold the glass internal lite in place relative thereto.

In further exemplary aspects, the frame is configured to at least partially clamp to the door slab, e.g., partially in one or more discrete locations around the exterior circumference of the frame. In additional exemplary aspects, the frame is configured to at least partially clamp to the glass internal lite, e.g., partially in one or more discrete locations around the interior circumference of the frame.

In further exemplary aspects, the frame is provided in at least two clamping pieces, with a first side clamping to a second side across the door slab to secure the frame relative thereto. In exemplary aspects, a plurality of fasteners, such as bolts, screws, etc., are provided to secure the frame relative to the door slab and/or the glass internal lite. In exemplary aspects, the plurality of fasteners extend through a first frame piece and between the interior and exterior portions to directly engage the second frame piece on the other side, sandwiching the glass internal lite in the interior periphery of the first and second frame pieces and sandwiching the door slab in the exterior periphery of the first and second frame pieces for easy installation or removal of glass kit unit relative to the door slab.

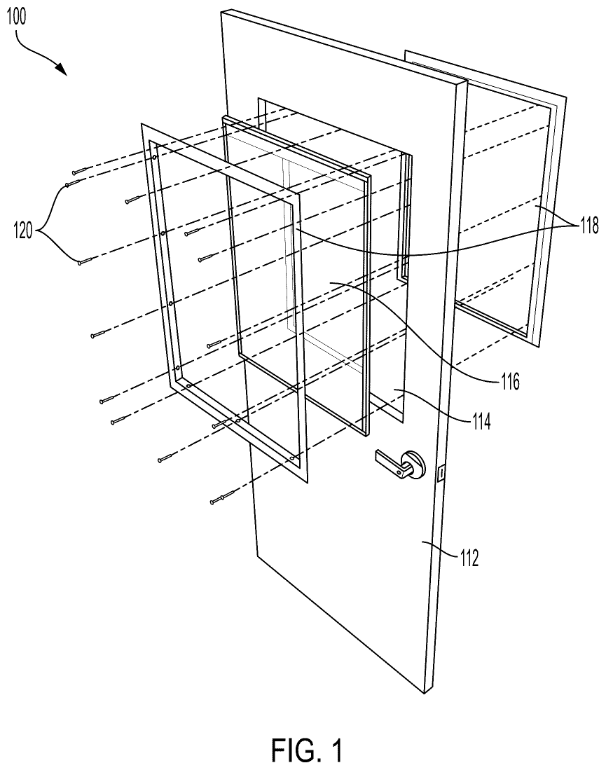

Referring to FIG. 1, an exemplary door is shown generally at 100 includes a door slab 112 with an opening 114 that is sized to receive an exemplary smart glass unit or glass lite unit (e.g., the opening may correspond to readily available non-smart glass insulated glass units (IGUs) provided with a door or available as a door option). Smart glass 116 is provided between exemplary frame components 118, which in this case includes front and back frame components that sandwich the smart glass 116 in an interior portion thereof and which sandwich the door slab 112, using fasteners 120 that extend through the frame components 118, but interior to the periphery of the opening 114 and exterior to the periphery of the smart glass 116.

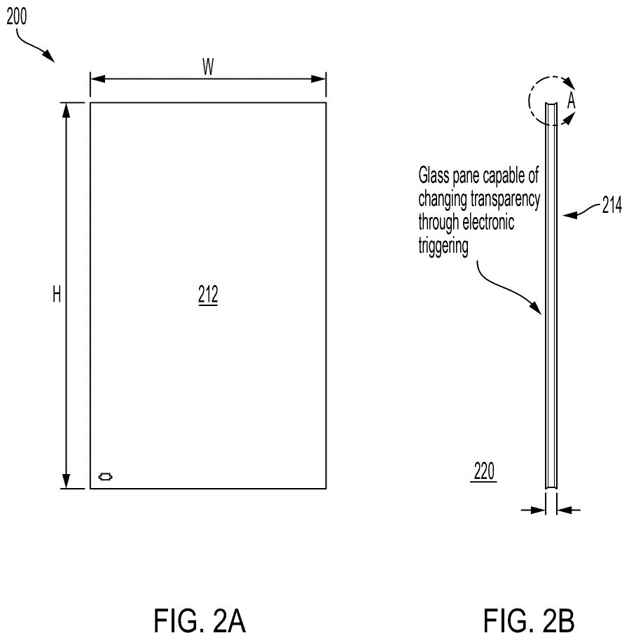

FIG. 2A shows a front elevation view of an exemplary insulated glass unit (IGU) generally at 200. This can be double or triple pane glass in some combination of tempered and/or laminated glass panes, as shown (though embodiments described herein contemplate other constructions, e.g., single pane glass, etc.). FIG. 2B shows a side elevation view of the same, showing the exemplary layering of the pane 212 generally at 214. One exemplary set of dimensions for FIGS. 2A and 2B are also provided, though it should be recognized that any size or shape of a smart glass pane, and of the related frame provided around the smart glass pane, is contemplated herein.

Further, the smart glass aspect can be an internal layer or be a film or laminate, such that the smart glass pane can change state or transparency of the glass according to modification by application of an electronic signal. This can be achieved with a variety of technologies, including but not limited to use of electrochromic, electrophoretic, liquid crystal, suspended particle, thermochromic, photochromic, interferometric modulator, plasmonic, Gyricon, electrowetting technology, etc.

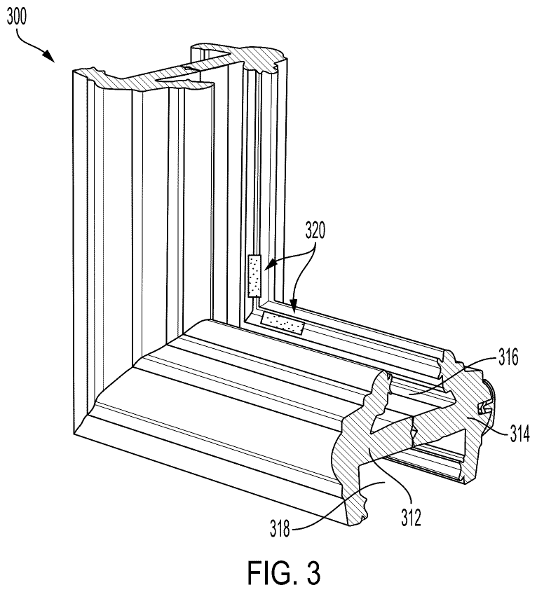

In additional exemplary aspects, the frame includes conductive contact pads on an interior periphery portion to provide power from the power source to conductive contact points on the smart glass. This is shown, e.g., in the exemplary embodiment of FIG. 3, with a frame component shown generally at 300, comprising a first frame piece 312 and an opposing second frame piece 314. Together, the illustrated exemplary frame 300 defines an interior channel 316, configured to hold or clamp smart glass, and an exterior channel 318, configured to hold or clamp onto an exterior structure, such as the periphery of a door slab opening, a frame of another structure, such as a patio door or window frame, etc. Additionally, contact pad(s) 320 are illustrated as described above, for power to the smart glass, data as described below, etc.

We note that the illustrated exemplary frame(s) can be designed to maintain aesthetic appeal appropriate for individual applications, doors, etc., e.g., as a standard door lip lite, while also providing power/current as necessary for the connection with the electronic enabled glass pane.

In other exemplary aspects, the frame includes conductive contact pads interior periphery portion to provide data from a data connection to conductive contact points on the smart glass.

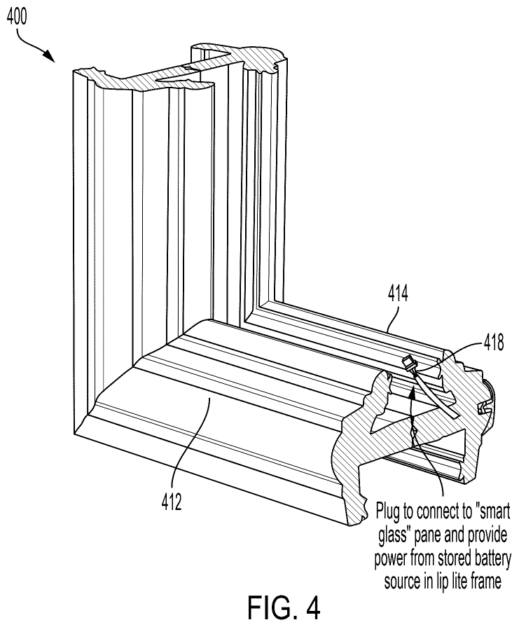

FIG. 4 illustrates an exemplary embodiment, wherein a frame similar to that in FIG. 3 includes a wired connector/plug 419 from the power source and/or data connection provided within the frame 400 (in either or both of frame portions 412 and 414).

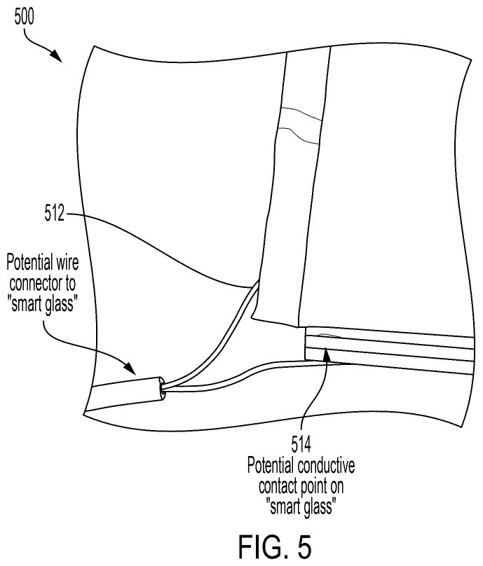

FIG. 5 illustrates an exemplary embodiment, for use with e.g., a frame similar to that in FIG. 3, wherein the smart glass interface, shown generally at 500, includes both a wired connection 512 and a contact point 514, which could interface with a contact pad 320 in FIG. 3.

In additional exemplary aspects, the at least one power source is a battery, wireless power unit, solar power unit, or other power source contained within or around the frame. For wireless power and/or data units, in exemplary aspects, the frame includes a receiver or receiver and transmitter.

In further exemplary aspects, a wire connector is provided at least partially through the frame to an external portion thereof to allow for connection to one or more power or data sources, e.g., a wireless power source and/or data connection, a solar power source, etc., as a supplemental power or data source or as an alternative to one or both of power and data provided from within the frame.

In exemplary aspects, the smart glass is of the type that has memory such that it retains its current state (e.g., remaining opaque or transparent in the powered off state) for a predetermined amount of time unless a power source provides a switching signal to induce a state transfer.

In exemplary aspects, the state of transparency will only require an electronic signal to create a status change switch, without requiring maintenance of any state through a continuous application of current. As such, the amount of continued current draw required to maintain a given state of transparency or translucency is greatly reduced over standard “smart glass” approaches. Further, smaller power sources (e.g., AA, AAA, button batteries, etc.) may be used, which can be easily disposed in or around the frame of the smart glass, providing a minimalist and aesthetic standalone powered smart glass unit/system. Such batteries can be disposable consumer-available cell battery types, in which an access door to remove and replace the batteries can be provided in the frame, e.g., in the outer facing region of the lite frame). The present disclosure also contemplates a variety of rechargeable secondary cell technologies, in consumer form factor or otherwise, e.g., integrated into the frame such that there is no need for an externally facing access panel (allowing for in-situ recharging via a port or other recharging mechanism (e.g., inductive)).

In other exemplary aspects, a portion of the frame provides, as mentioned above, an accessible opening to replace or recharge a power source provided therein, e.g., as a battery compartment.

In other exemplary aspects, the power source/current drawn can be provided through external energy wave signals, in which case, rather than a battery, the frame can be designed with an integrated receiver (e.g., for radio frequency (RF), solar, infrared, or other wireless transmitted energy sources). Such receiver can be integral to the frame and/or connected externally alone or in conjunction with a secondary internal frame power source.

In further exemplary aspects, the frame includes a user interface, e.g., a trigger, button (e.g., a physical push button), contact pad, display, etc., that allows user control of the smart glass. In further exemplary aspects, the glass lite unit includes a wireless data interface within the frame communicating with a user device, such as a smart phone, wireless home control unit, etc., for control of the smart glass. In additional or alternative exemplary aspects, a sensor in the frame and/or a sensor in wireless data communication with the smart glass (or other wireless signal, e.g., via radio frequency identification (RFID), Bluetooth, wifi, zigbee, zwave, Infrared, or other wireless transmission mechanism) is used to trigger a change in or otherwise control the smart glass.

Exemplary aspects of technical solutions described herein relate to, among other things, devices, systems, methods, computer-readable media, techniques, and methodologies for using or managing computer interfaces for smart glass devices, which may be provided, e.g., through wireless data interfaces.

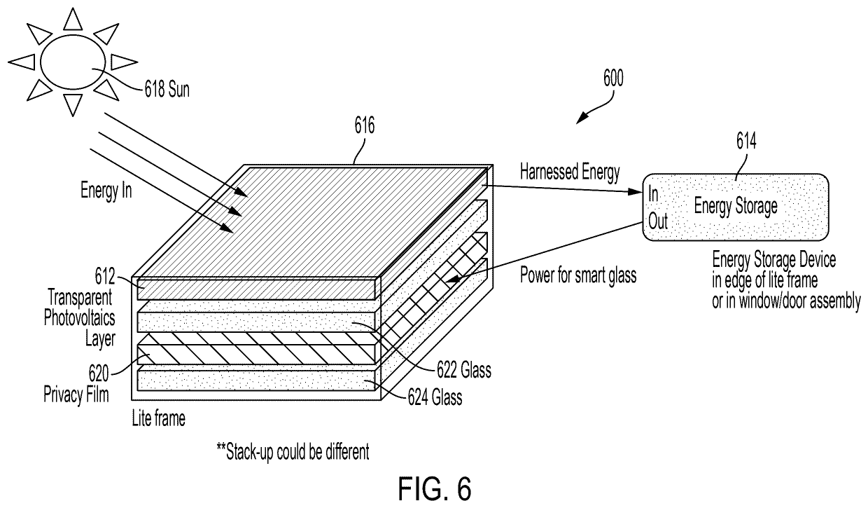

FIG. 6 illustrates a schematic of an exemplary embodiment of a lite frame stack up, shown generally at 600, that includes a transparent photovoltaics layer 612 (providing a clear solar panel), that can be used to recharge an energy storage device 614 (e.g, battery(s), capacitor(s), super capacitor(s), etc.,) located in the lite frame 616 (or in a door or window assembly). This allows for a self-sustaining system that never needs to be manually recharged by an external device, thus being less of a burden to its users. Additionally, this self-sustaining system is environmentally friendly since it harnesses the power of the sun 618 and doesn't require single-use batteries which produce electrical waste. As is illustrated in the shown exemplary embodiment, the transparent photovoltaics layer 612 is provided over a layer of privacy film 620 (which is powered by the energy storage/power source 614) that is sandwiched between two glass layers 622, 624.

The descriptions of the various aspects of the present invention have been presented for purposes of illustration but are not intended to be exhaustive or limited to the aspects disclosed. Many modifications and variations will be apparent to those of ordinary skill in the art without departing from the scope and spirit of the described aspects. The terminology used herein was chosen to best explain the principles of the aspects, the practical application or technical improvement over technologies found in the marketplace, or to enable others of ordinary skill in the art to understand the aspects described herein.

Various aspects of the invention are described herein with reference to the related drawings. Alternative aspects of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains,” or “containing,” or any other variation thereof are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any aspect or design described herein as “exemplary” is not necessarily to be construed as preferred or advantageous over other aspects or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, smart door systems.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

What is claimed is:

1. A lite frame comprising:
a frame, wherein the frame comprises:
an internal channel configured to hold a smart glass pane;
an external channel configured to engage a supporting periphery of an opening;
at least one power source provided within the frame; and
at least one connector configured to connect the power source to the smart glass pane.

2. A lite frame in accordance with claim 1, wherein the opening is an opening in a door or door slab.

3. A lite frame in accordance with claim 1, wherein the frame comprises a first frame piece and a second frame piece, each configured to mate and clamp over one or both of the smart glass pane and the supporting periphery of an opening.

4. A lite frame in accordance with claim 3, wherein the frame is configured to clamp over both of the smart glass pane and the supporting periphery of an opening and includes fasteners extending from the first frame piece to the second frame piece to provide clamping force.

5. A lite frame in accordance with claim 1, wherein the frame includes disposable or rechargeable batteries provided therein.

6. A lite frame in accordance with claim 5, wherein the disposable or rechargeable batteries are housed in a cavity with an access cover.

7. A lite frame in accordance with claim 1, wherein the power source is provided via wireless power collected via a receiver housed within the frame.

8. A lite frame in accordance with claim 7, wherein the wireless power source is based on one or more of radio frequency (RF), solar, and infrared technology.

9. A lite frame in accordance with claim 1, wherein the frame includes at least one contact pad to provide power on interior channel, configured to engage a corresponding contact point on the smart glass pane.

10. A lite frame in accordance with claim 9, wherein the frame includes at least two contact pads to provide power on interior channel, configured to engage corresponding contact points on the smart glass pane.

11. A lite frame in accordance with claim 9, wherein the frame additionally includes at least one wire connector to provide power, configured to engage a corresponding wire connector on the smart glass pane.

12. A lite frame in accordance with claim 1, wherein the smart glass pane is of the type that has memory such that it retains its current state for a predetermined amount of time unless a power source provides a switching signal to induce a state transfer.

13. A lite frame unit in accordance with claim 1, wherein the frame includes a user interface allowing user control of the smart glass.

14. A lite frame in accordance with claim 13, wherein the user interface comprises a physical button trigger.

15. A lite frame in accordance with claim 13, wherein the user interface comprises a receiver for a wireless control signal.

16. A lite frame in accordance with claim 1, wherein the frame is configured to engage smart glass pane that further includes a transparent photovoltaics layer thereover configured to charge the at least one power source.

17. A lite frame unit stackup, comprising:
a frame; and
a rechargeable energy storage device provided in or around the frame;
a first glass layer provided within the frame;
a second glass layer provided within the frame; and
a transparent photovoltaics layer provided over or between the first and second glass layers, the transparent photovoltaics layer configured to recharge the rechargeable energy storage device.

18. A lite frame unit stackup in accordance with claim 17, further comprising a layer of privacy film provided over or between the first and second glass layers.

19. A lite frame unit stackup in accordance with claim 18, wherein the privacy film layer and the transparent photovoltaics layer are sandwiched between the first and second glass layers.

20. A lite frame unit in accordance with claim 18, the privacy film is connected to and powered by one or both of the transparent photovoltaics layer and the rechargeable energy source.

21. A lite frame unit in accordance with claim 18, wherein the transparent photovoltaics layer is configured to recharge the rechargeable energy source, which is configured to power the privacy film.
